(19) United States
(12) Patent Application Publication
(10) Pub. No.: US 2004/0180712 A1
(43) Pub. Date: Sep. 16, 2004

(54) Wireless multiple server gaming system having customizable user interface features

(76) Inventors: David S. Forman, Rancho Mirage, CA (US); Rick G. White, Bermuda Dunes, CA (US)

Correspondence Address: WEISS & MOY PC, 4204 NORTH BROWN AVENUE, SCOTTSDALE, AZ, 85251, US

(21) Appl. No.: 10/386,202

(22) Filed: Mar. 10, 2003

(51) Int. Cl. A63F 13/00

(52) U.S. Cl. 463/17

(57) ABSTRACT

A wireless multiple server gaming system and method having customizable user interface features provides enhancements to wireless gaming systems. The system includes a scanning device or other receiving device for the input of user-provided graphics that are used to customize features of a gaming device screen. The user interface may include backgrounds, daubers, numbers and other areas that are customized to the users preferences. Additionally, the improved user interface provides special hot-ball indicia for indicating the presence of a hot-ball (also known as “fish ball”, “pig ball”, “fire ball”, “cash ball”, “money ball” or “flash ball”) in one or more game cards, and a pop-up navigation menu on the card display for navigating amongst various games. The system includes multiple game servers coupled through a special proxy server that provides interconnectivity for the wireless game units and the servers, whereby multiple gaming types are supported at the wireless units simultaneously.

### BACKGROUND OF THE INVENTION

1. Field of the Invention

The present invention relates generally to client-server gaming systems and more specifically, to a system providing customizable user interface features.

2. Background of the Invention

Electronic gaming systems, including dedicated game boards and wireless client/server systems, have proliferated for use in bingo, keno and other gaming as technologies have yielded low-cost and portable devices. However, such systems are typically dedicated to a single type of game or connected to a single server providing a particular type of game. Requirements for control of various class games as provided by local or federal regulations also dictate that certain systems are isolated in conformance with gaming requirements. Therefore, various game class types are typically not available at a single portable gaming unit.

The software or firmware in portable gaming units is typically fixed, providing the same user interface to all gaming participants using a portable gaming unit. Navigation within gaming units is typically provided by a number of control buttons or in some cases, a menu interface displayed at an edge of the screen. Special variants of games such as bingo have special requirements for play that are typically not incorporated within standardized gaming units.

Therefore, it would be desirable to provide a method and system providing a unique user interface including navigational controls for gaming systems. It is further desirable to provide customization of the user interface to enhance user interest. It would also be desirable to provide user interface capabilities compatible with special gaming requirement. Lastly it would be desirable to provide a gaming system capable of efficiently providing multiple types of games at a portable wireless unit.

### SUMMARY OF THE INVENTION

The above objective of providing unique user interface for a gaming system, play of multiple game class types, and a customizable user interface having improved navigation is provided in a method and system.

The gaming device includes one or more of various user interface features such as a pop-up navigation menu for activation from a play area of the gaming device that provides navigation amongst a plurality of available games. Other user interface features include insertion of portions of user-provided graphics via a card reader or scanner in order to customize the playing area, number display, playing area backgrounds or other areas of the graphical display of the portable gaming device. The system may include a scanner, card reader or both for input of user-provided graphics. The system may provide multiple gaming types via a connection of multiple servers to a communications intermediary server that provides efficient connection and security among the multiple servers.

The methods of the present invention may be embodied a computer program products including program instructions for execution within a portable gaming device or system.

The foregoing and other objectives, features, and advantages of the invention will be apparent from the following, more particular, description of the embodiments of the invention, as illustrated in the accompanying drawings.

### BRIEF DESCRIPTION OF THE DRAWINGS

FIG. 1 is a block diagram depicting an electronic gaming system in accordance with an embodiment of the present invention.

FIG. 2 is a simplified block diagram depicting components of an electronic gaming system in accordance with an embodiment of the present invention.

FIG. 3 is a block diagram depicting a wireless gaming unit in accordance with an embodiment of the present invention.

FIG. 4 is a pictorial diagram depicting a user interface of a wireless gaming unit in accordance with an embodiment of the present invention.

FIG. 5 is a pictorial diagram depicting a user interface of a wireless gaming unit in accordance with another embodiment of the present invention.

FIG. 6 is a pictorial diagram depicting a user interface of a wireless gaming unit in accordance with yet another embodiment of the present invention.

### DETAILED DESCRIPTION OF THE PREFERRED EMBODIMENTS

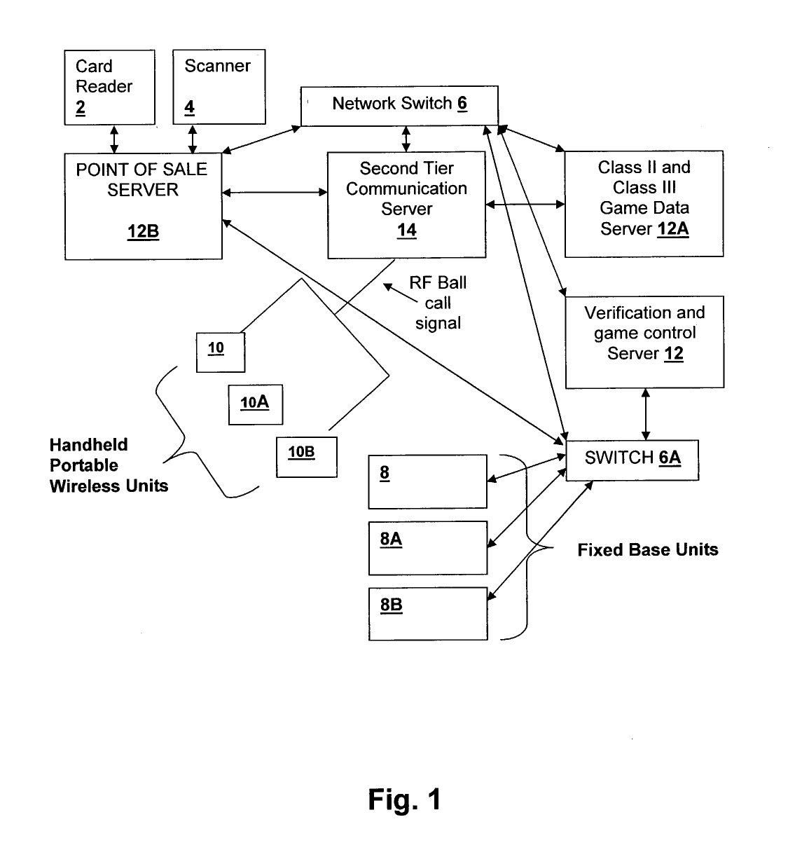

Referring now to the Figures, and with particular reference to FIG. 1, an electronic gaming system in accordance with an embodiment of the present invention is depicted in a block diagram. The system is a multi-server system providing enhanced security and efficiency within a wireless electronic gaming environment. A point of sale server 12B provides for sale and consequent loading of game cards and sets of game cards for playing bingo and other games served by the system. Handheld portable wireless units 10, 10A and 10B are programmed by point of sale server via an infrared interface, and the programming includes the download of bingo game information for generating electronic representations of bingo cards used during play on a user interface of portable wireless units 10, 10A and 10B. While the system described uses a wireless infrared (IR) interface for downloading of gaming information to portable wireless units 10, 10A and 10B in a download mode, secure radio-frequency communications (RF) may be used within the system as well as hard-wired temporary connections for download of gaming information as has been practiced in past systems.

Point of sale server 12B is coupled to an image scanner 4 and a card reader 2 for providing certain features of the system. Scanner 4 is used to scan user-supplied graphics for download or transmission to portable wireless units 10, 10A and 10B for customization of a user interface of the present invention. Various items in the user interface, including backgrounds, daubers (the cursor used to play bingo) and other portions of the user interface can be decorated or replaced with user-supplied graphics, providing an enhanced gaming experience through personalization of the user interface of portable wireless units 10, 10A and 10B.

Card reader 2, which also may include card write capability, can also be used to load and/or store user-supplied graphics. Cards issued to players can identify a player (user) uniquely, providing a mechanism for quickly accessing player information including graphics scanned by scanner 4 or uploaded from another location. Also, if card reader 2 is a memory card reader (as opposed to a magnetic stripe reader or other similar card type reader) the cards themselves may contain graphics input by scanner 4, uploaded by the player at another location or with another device such as a personal computer with a card writer attached. Cards may also contain credits for games, monetary value and other information consistent with a gaming player's use of the system.

Point of sale server 12B is also coupled to a network switch 6 providing network access to other coupled servers and switches, but also coupled directly to an intermediary second-tier communication server 14 that communicates via RF signals with portable wireless units 10, 10A and 10B. Generally, intermediary server 14 provides RF ball call information to portable wireless units 10, 10A and 10B as games are played to provide a path secure from general network access for the ball call information, which represents actual monetary or other value as the calls determine winners and therefore must be secured against hacking and other unauthorized access. Intermediary server 14 provides such security as the RF ball call path is isolated from the general network. Intermediary server 14 also provides communications efficiency as the RF communication with portable wireless units 10, 10A and 10B is handled completely from intermediary server 14 avoiding a drain on other network resources. Multiple intermediary servers may be provided for the implementation of the system in large halls or when many portable wireless units are used on the system.

Another function of intermediary server 14 is to isolate Class II and Class III games within the system. Class II and Class III game data is provided on a direct connection from Class II and Class III game data server 12A, which can then be transmitted via the RF link from intermediary server 14 to portable wireless units 10, 10A and 10B.

A plurality of fixed base gaming units 8, 8A and 8B are coupled to a switch 6A connecting them to point of sale server 12B and a verification and game control server 12. Verification and game control server 12 controls the progress of the various games and provides verification of wins at the completion of each game. Fixed base units are verified directly through the network connection to verification and game control server 12, while portable wireless units 10, 10A and 10B are generally verified through an IR link to a verification station provided by verification and game control server 12 (there is no requirement that the actual server and verification station be co-located). Separation of verification and point of sale functions provides increased security and efficient operation as the verification locations and servers are separates from the point of sale locations and servers.

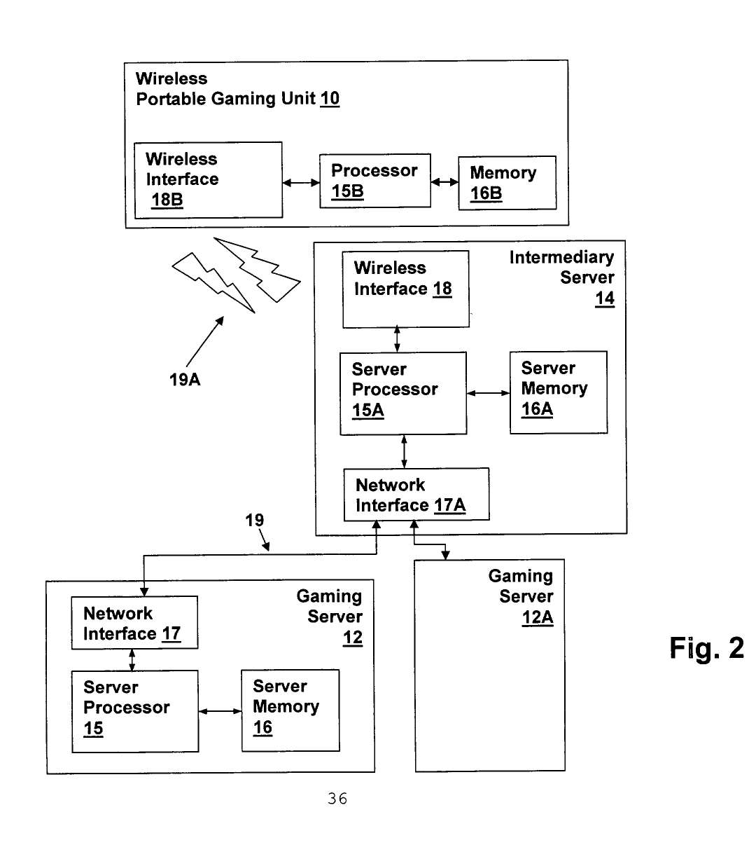

Referring now to FIG. 2, details of a server system in accordance with another, simplified embodiment of the invention are shown. A gaming server system 12 includes a server processor 15 for executing program instructions is coupled to a server memory 16 containing program instructions embodying methods of the present invention. Server processor 15 is also coupled to a network interface 17 for connection via a network connection 19 to intermediary server 14. Portable wireless gaming unit 10 includes a processor 15B coupled to a memory 16B and a wireless interface 18B for connection to intermediary server 14. Intermediary server 14 also includes a processor 15A coupled to a memory 16A for executing and storing program instructions including program instructions for supporting the RF wireless interface 19A to wireless portable gaming unit 10 and further for connection to servers 12 and 12A via a wired LAN connection provided through a network interface 17A coupled to processor 15A. The above-described networked computer system is exemplary only and should not be construed as limiting the scope of the present invention. The illustration provides an example of multiple gaming servers, where gaming server 12 is, for example a bingo game control server and where gaming server 12A may be a Class II or Class III gaming control server, coupled to an intermediary server 14 that provides security and efficiency in connecting gaming servers 12 and 12A to a plurality of portable gaming units such as wireless portable gaming unit 10.

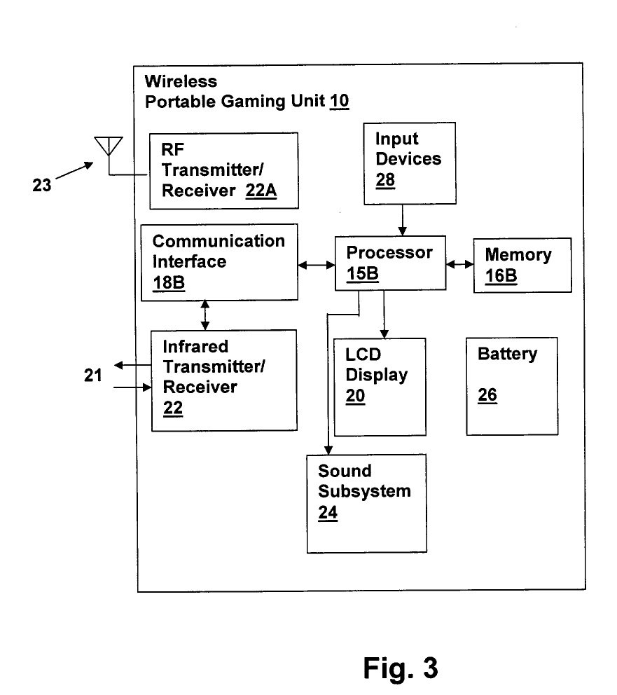

Referring now to FIG. 3, further details of wireless portable gaming unit 10 are shown in a block diagram. Gaming unit 10 connects to the servers described above via an IR optical interface 21 and an antenna 23. Antenna 22A is coupled to an RF transmitter/receiver 22A which is in turn coupled to a communications interface 18B that handles communications with a processor 15B. IR optical interface 21 is provided from an infrared transmitter/receiver 22 that is also coupled to communications interface 18B. Processor 15B is coupled to memory 16B which stores data and program instructions for providing features of the present invention, including the user interface methods described herein. Input devices 21 are also coupled to processor 15B for providing user input to the user interfaces. Input devices 21 may include a touchscreen integrated with an liquid crystal display (LCD) 20, which displays text and graphics in accordance with the user interfaces of the present invention. LCD display 20 is generally a color TFT LCD display, as the preferred embodiments of the present invention include color schemes and games that provide information and enhanced enjoyment of the gaming screens, including color information consistent with the user interfaces described below. A battery 26 provides power through connections (not shown) to the various components of gaming device 10 and sound system 24 provides an audible user interface to further enhance the gaming experience.

Referring now to FIG. 3, a gaming device 10 screen user interface display 32 is depicted in accordance with an embodiment of the present invention. User interface 32 provides a display of a “flashboard” 34 used to indicate ball calls in the bingo games played on gaming device 10. As the bingo numbers are called, they are indicated on the flashboard screen area 34, and in a particular feature of the present invention, a special number corresponding to a “hot ball” is indicated with a unique indicia 36. In the indicated example of the indicia 36, the box surrounding the “hot ball” number (also known as “fish ball”, “pig ball”, “fire ball”, “cash ball”, “money ball” or “flash ball”) is provided with a flaming box motif. Other indicia may be used such as colors, flashing color or box frame and the indicia may be animated such as providing animated flames to further call attention to the “hot ball” number.

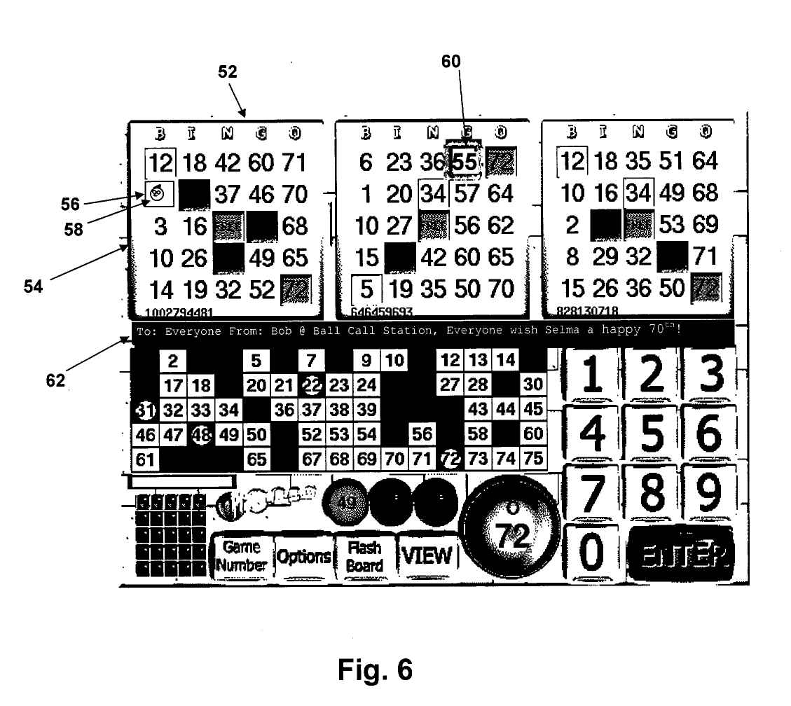

By way of explanation, a hot ball number is a number that provides an alternative mechanism of winning in a bingo game. The hot ball number may be specially called, or it may be the taken as the first call in a game, or determined by some other means. When a player gets a bingo (i.e., a straight line combination of calls or other pattern required by special bingo games), if the hot ball is the last number called in the bingo combination, the hot ball payout is made to the player. As an alternative, if the hot ball number is present at all in a winning bingo combination, a payout may be made. Previous game cards and gaming systems have provided no way of indicating a hot ball number and the use of the frame as illustrated to provide an indicia prevents interference with the color scheme or numbering scheme in user interface display 32. However, other indicia provided in the number square or on the number itself (graphic color, etc. including personalized graphics described elsewhere herein, may be used to indicate the hot ball). The hot ball may also be indicated via the indicia in other locations such as a separate flashboard graphical display coupled to one of the gaming servers in the system that is visible to some are all players, such as a large display mounted on a wall. The hot ball indicia may also be displayed on the bingo card representations of the user interfaced as is illustrated in FIG. 6 and described below.

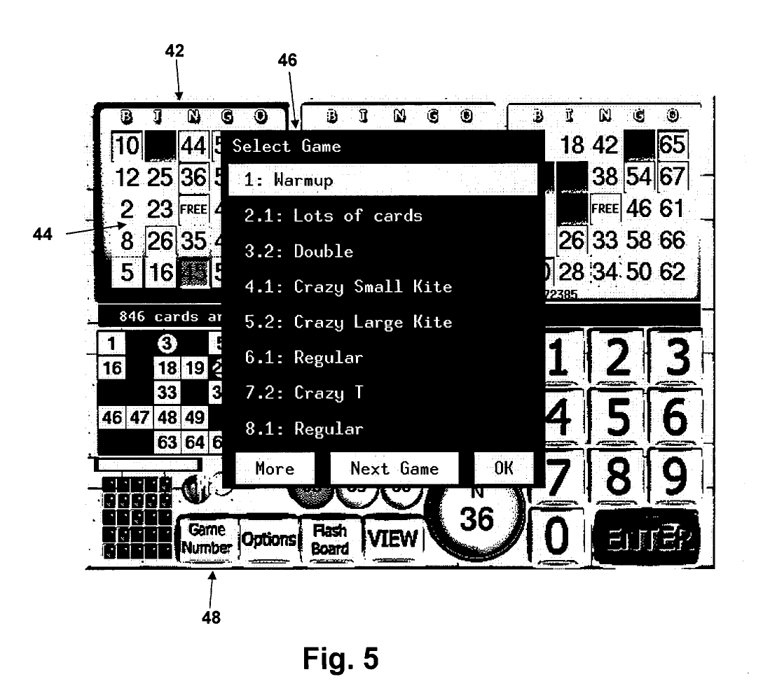

Referring now to FIG. 5, another feature of the user interface of the present invention is depicted. Within user interface 42 which provides a playing screen including a plurality of card representations 44, a pop-up menu providing navigation amongst a plurality of games is provided, when a user activates the “game number” 48 area via a touchscreen, cursor movement or provided as a separate game number key on the gaming device 10 housing. Pop-up menu 46 permits navigation to games in any sequence, in contrast to previous gaming system operation which typically require game play in sequence as dictated by the system. Pop-up menu 46 provides flexibility in gaming that further enhances enjoyment of the gaming experience through letting an individual player have more control over their gaming options.

Referring now to FIG. 6, yet other features of the user interface of the present invention is depicted. One feature is consistent with the personalized graphics described above with respect to point-of-sale server 12B and the coupled input devices. Within user interface 52 which provides a playing screen including a plurality of card representations 54, a dauber 56 that is personalized with a user-supplied graphic 58 is depicted. Graphic depicts a caricature drawing of a face, but will generally be a photograph of a friend, loved one, or other person, place or item familiar to the player. While dauber 56 is a convenient location for personalization, other areas (and areas within other screens) of user interface display 52 may be customized with user-supplied graphics in accordance with other embodiments of the present invention. In particular, the background of the user interface display may be provided as a larger graphic or a tiled small graphic that is supplied by the player (user). Personalization provides enhanced enjoyment of the games through familiarity and the other advantages of personalization as described above. Players can transport their graphic images between systems using cards readable via the card readers described above, including flash cards and other memory cards that may contain digital photographs or images in other computer-readable formats for input to point of sale server 12B and subsequent transfer to one or more of gaming devices such as gaming device 10.

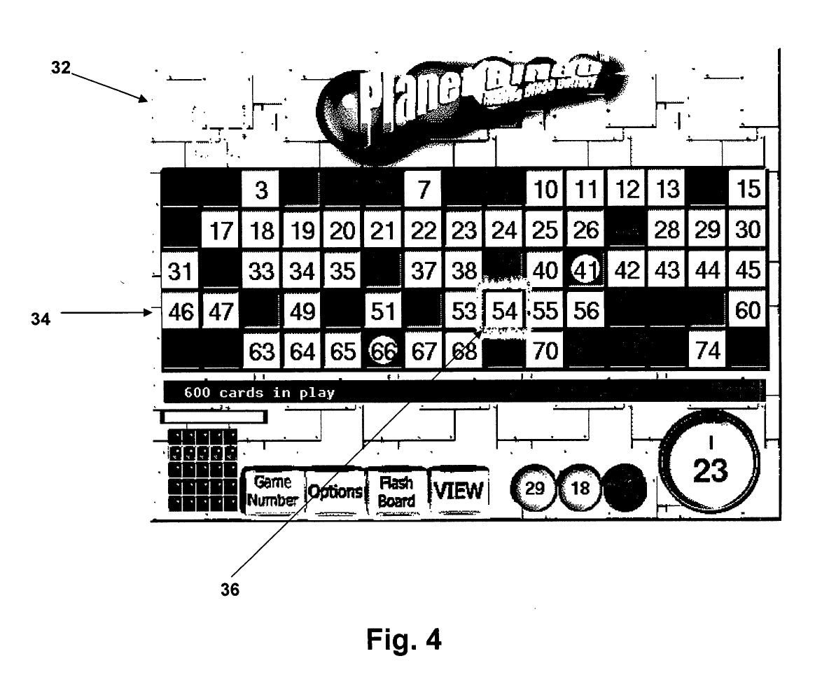

Also in FIG. 6, a hot ball indicia 60 is illustrated for user interfaces depicting bingo card representations (in contrast to the flashboard user interface depiction of FIG. 4). As soon as a hot ball is determined, indicia 60 may be added in static or animated form to call attention to the hot ball in the current game.

Also in FIG. 6, a messaging feature of the system is displayed on user interface. In gaming halls it is customary for the caller to make announcements, such as player birthdays, etc. or information about the games to be played over a microphone. The portable wireless gaming device 10 of the present invention provides an alternative messaging system for the caller to make an announcement to the players on user interface 52, via a message area 62 that is displayed when a communication from the caller, other game player or other game manager wants to make an announcement. The announcement may be a “broadcast” message to all players, or may be an individual message address to a particular wireless gaming device.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. An electronic gaming system, comprising:
at least one game server having a interface for providing transmission and reception of gaming information; and
at least one portable gaming device, coupled to said interface in at least a download mode, wherein the portable gaming device includes a graphical display for displaying a user interface of the portable gaming device, and wherein the user interface includes customizable graphics selected by a user of said portable gaming device, whereby enjoyment of said gaming system by said user may be enhanced.

2. The electronic gaming system of claim 1, wherein said interface is a wireless interface and wherein said portable gaming device is coupled to said game server continuously via said interface.

3. The electronic gaming system of claim 1, further comprising an image scanner coupled to said at least one game server for scanning a graphical image provided by said user, and wherein said game server receives said graphical images and transmits at least a portion of said graphical image to said portable gaming device, whereby said user interface may be customized by insertion of said portion of said graphical image.

4. The electronic gaming system of claim 3, wherein said game server transmits bingo game information to said portable gaming device and wherein said user interface is customized by providing a moving dauber bitmap including said portion of said graphical image.

5. The electronic gaming system of claim 1, wherein said game server transmits bingo game information to said portable gaming device and wherein said user interface is customized by providing a background including said portion of said graphical image.

6. The electronic gaming system of claim 1, wherein said game server transmits bingo game information to said portable gaming device and wherein said user interface is customized by providing number indicia containing said portion of said graphical image.

7. The electronic gaming system of claim 1, wherein the user interface further includes a pop-up menu available anywhere in a play area of said user interface for navigating amongst a plurality of screens for display of a plurality of available games.

8. The electronic gaming system of claim 1, further comprising a card reader coupled to said at least one game server for reading information including access to a graphical image associated with said user, and wherein said game server receives said graphical images from said card reader and transmits at least a portion of said graphical image to said portable gaming device, whereby said user interface may be customized by insertion of said portion of said graphical image.

9. The electronic gaming system of claim 8, wherein said card reader further is a card writer, and further comprising an image scanner coupled to said at least one game server for scanning a graphical image provided by said user, and wherein said game server receives said graphical image and writes at least a portion of said graphical image to said card.

10. An electronic gaming system, comprising:
at least one game server having a interface for providing transmission and reception of gaming information; and
at least one portable gaming device, coupled to said interface in at least a download mode, wherein the portable gaming device includes a graphical display for displaying a user interface of the portable gaming device, and wherein the user interface includes a pop-up menu available anywhere in a play area of said user interface for navigating amongst a plurality of screens for display of a plurality of available games.

11. The electronic gaming system of claim 10, wherein said pop-up menu provides for selection amongst games active on said gaming server.

12. The electronic gaming system of claim 10, wherein said at least one game server comprises multiple game servers, and wherein said pop-up menu provides for selection between games available on a first one of said multiple game servers and games available on a second one of said multiple game servers.

13. The electronic gaming system of claim 10, wherein said portable gaming device includes a dedicated game selection user selection input means, whereby said pop-up menu is activated by activation of said dedicated game selection user input means.

14. The electronic gaming system of claim 1, wherein said pop-up menu provides a plurality of navigation options for navigating between games in any sequence.

15. An electronic gaming system, comprising:
at least one game server having a interface for providing transmission and reception of gaming information; and
at least one portable gaming device, coupled to said interface in at least a download mode, wherein the portable gaming device includes a graphical display for displaying a user interface of the portable gaming device, and wherein the user interface includes hot ball indicia for indicating a hot ball number active in a game on said gaming server within a number frame displayed on said user interface.

16. The electronic gaming system of claim 15, wherein said user interface is an interface displaying at least one bingo card representation, and wherein said indicia is provided on said bingo card representation.

17. The electronic gaming system of claim 15, wherein said user interface is an interface displaying a representation of a flashboard, and wherein said indicia is provided on said flashboard representation.

18. The electronic gaming system of claim 15, wherein said hot ball indicia is a static representation of flames.

19. The electronic gaming system of claim 15, wherein said hot ball indicia is an animated representation of flames.

20. The electronic gaming system of claim 15, wherein the hot ball indicia is provided on a border surrounding a number display area containing said hot ball number.

21. The electronic gaming system of claim 15, wherein the hot ball indicia is provided on a display of said hot ball number.

22. The electronic gaming system of claim 15, wherein the hot ball indicia is provided by a user-supplied graphic.

23. The electronic gaming system of claim 15, further comprising an electronic flashboard coupled to said gaming server for displaying calls in a game active on said gaming server, and wherein an area of said flashboard is updated with a second indicia of said hotball when said hot ball number is called.

24. The electronic gaming system of claim 23, wherein said area of said flashboard is provided with an animation calling attention to said called hotball.

25. The electronic gaming system of claim 15, further comprising an image scanner coupled to said at least one game server for scanning a graphical image provided by said user, and wherein said game server receives said graphical images and transmits at least a portion of said graphical image to said portable gaming device, whereby said hot ball indicia may be customized by insertion of said portion of said graphical image.

26. A wireless gaming system, comprising:
a plurality of portable gaming devices;
multiple game servers having a interface for providing transmission and reception of gaming information, at least a first one of said multiple game servers associated with a first type of game and at least a second one of said multiple game servers associated with a second type of game; and
an intermediary server coupled to said multiple game servers and providing a wireless interface for connection of said portable gaming devices, whereby communication with said portable gaming devices is managed by said intermediary server.

27. The electronic gaming system of claim 26, further comprising at least one point of sale server unit coupled to at least one of said game servers and further coupled to said portable gaming devices in at least a download mode for downloading games into said portable gaming devices.

28. The electronic gaming system of claim 27, further comprising an image scanner coupled to said point of sale server for scanning a graphical image provided by said user, and wherein said point of sale server receives said graphical images and transfers at least a portion of said graphical image to said portable gaming device, whereby indicia of a user interface of said portable gaming devices may be customized by insertion of said portion of said graphical image.

29. The electronic gaming system of claim 26, wherein at least one of said multiple gaming servers is a Class II gaming server coupled to said intermediary server for exchanging Class II gaming data with said portable gaming devices.

30. The electronic gaming system of claim 26, wherein at least one of said multiple gaming servers is a Class III gaming server coupled to said intermediary server for exchanging Class III gaming data with said portable gaming devices.

31. A wireless gaming system, comprising:
a plurality of portable gaming devices;
at least one game server having a message input capability for providing transmission of message information from a game manager to game players, by displaying said message information on a user interface of at least one of said portable gaming devices.

32. The wireless gaming system of claim 31, further comprising an intermediary server coupled to said at least one game server and providing a wireless interface for connection of said portable gaming devices, whereby communication of said message information to said portable gaming device is managed by said intermediary server.

33. A method of playing a game on an electronic gaming system having portable gaming devices, comprising:
receiving a graphical image from a game player;
transferring electronic data representing said graphical image into a server of said gaming system; and
displaying at least a portion of said graphical image on a user interface of one of said portable gaming devices.

34. The method of claim 33, wherein said transferring is performed by wireless communication from said server to said portable gaming device.

35. The method of claim 33, wherein said receiving comprises scanning a graphical image with an image scanner.

36. The method of claim 32, wherein said user interface is a user interface for a bingo game and wherein said graphical image is used as a daumber in said bingo game.

35. The method of claim 31, wherein said receiving comprises reading said graphical image from a card having a signal-bearing media storing said graphical image provided by said game player.

38. A method of playing a game on an electronic gaming system having a portable gaming device, comprising:
receiving a user input for selecting amongst a plurality of available games on said electronic gaming system;
generating a pop-up menu providing a plurality of options for selecting between said plurality of games;
receiving a second user input selecting a particular one of said options; and
switching a display of said portable gaming device to a game associated with said particular option.

39. The method of claim 38, wherein said generating generates a pop-up menu including a list of games active on a server of said gaming system.

40. The method of claim 38, wherein said system includes multiple gaming servers, and wherein said generating generates a pop-up menu providing for selection between games available on a first one of said multiple gaming servers and games available on a second one of said multiple gaming servers.

41. The method of claim 38, wherein said switching is performed amongst games in any sequence in response to said second receiving.

42. A method of playing a game on an electronic gaming system having a portable gaming device, comprising:
receiving an indication of a hot ball number at said portable gaming device; and
displaying a user interface of said portable gaming device including a hot ball indicia for indicating said hot ball number.

43. The method of claim 42, wherein said displaying displays a user interface including at least one bingo card representation, and displays said indicia is provided on said bingo card representation.

44. The method of claim 42, wherein said displaying displays a user interface including a bingo flashboard representation, and displays said indicia on said flashboard representation.

45. The method of claim 42, wherein said displaying further comprises animating said indicia to call attention to said hot ball number.

46. The method of claim 42, further comprising displaying a second indicia indicating said hot ball number on a flashboard viewable by a room of players.

47. A method of managing communications in a wireless gaming system comprising a plurality of portable gaming devices, multiple game servers, and an intermediary server coupled to said multiple game servers, comprising:
transferring game data to said intermediary server from said multiple game servers; and
communicating said game data to said portable gaming devices, whereby isolation is provided between said multiple game servers.

48. The method of claim 47, wherein said system further comprises at least one point of sale server unit coupled to at least one of said multiple game servers and coupled to said portable gaming devices in at least a download mode, and further comprising downloading games into said portable gaming devices from said point of sale server.

49. The method of claim 48, further comprising:
receiving a graphical image from a game player;
scanning electronic data representing said graphical image into said point of said server; and
displaying at least a portion of said graphical image on a user interface of one of said portable gaming devices.

50. The method of claim 47, wherein at least one of said multiple servers is a Class II gaming server and wherein said method further comprises exchanging data between said portable gaming devices and said Class II gaming server via said intermediary server.

51. The method of claim 47, wherein at least one of said multiple servers is a Class III gaming server and wherein said method further comprises exchanging data between said portable gaming devices and said Class III gaming server via said intermediary server.

52. A method for managing a wireless gaming system, comprising:
receiving a message input from an input device coupled to a gaming server of said gaming system for a game manager;
transmitting said message input to one or more portable gaming devices; and
displaying said message on a user interface of said one or more portable gaming devices.

53. The method of claim 52, wherein said wireless gaming system further comprises an intermediary server coupled to said gaming server and providing a wireless interface for connection of said one or more portable gaming devices, whereby communication of said message information to said portable gaming device is managed by said intermediary server.
